(19) United States
(12) Patent Application Publication
(10) Pub. No.: US 2017/0293153 A1
(43) Pub. Date: Oct. 12, 2017

(54) LENTICULAR LENS FILMS AND 3D DISPLAY DEVICES

(71) Applicant: Wuhan China Star Optoelectronics Technology Co., Ltd., Wuhan (CN)

(72) Inventors: Hongqing CUI, Shenzhen (CN); Guowei ZHA, Shenzhen (CN)

(73) Assignee: Wuhan China Star Optoelectronics Technology Co., Ltd., Wuhan (CN)

(21) Appl. No.: 15/207,443

(22) Filed: Jul. 11, 2016

(30) Foreign Application Priority Data
Apr. 7, 2016 (CN) 2016102142311

(51) Int. Cl. G02B 27/22; G02B 27/26; G02B 1/04; G02B 3/00; G02B 5/30

(52) U.S. Cl. CPC G02B 27/2214; G02B 3/0006; G02B 5/3058; G02B 1/041; G02B 27/26

(57) ABSTRACT

A lenticular lens film includes a substrate, a plurality of lenticular lenses, and a plurality of wire grating polarizers. The substrate includes a front surface and a back surface. Each of curved surfaces of the lenticular lenses are arranged on the front surface of the substrate in parallel, and the curved surfaces of the lenticular lenses faces away from the front surface of the substrate. The wire grating polarizer includes a dielectric layer formed on the back surface of the substrate, and a metallic layer having a plurality of metal strips arranged on the dielectric layer, the metal strips are parallel to each other and are spaced apart from each other. In addition, the present disclosure also relates to a 3D display device.

### BACKGROUND OF THE INVENTION

### 1. Field of the Invention

The present disclosure relates to display technology, and more particularly to a lenticular lens film and a three dimensional (3D) display device.

### 2. Discussion of the Related Art

It is well known that the images may be more realistic when displayed by 3D technology, instead of 2D technology. In addition, the images are not limited to a plane of the screen. Regarding the naked-eye 3D technology, complicated auxiliary devices may be omitted, and thus is more suitable for users. Thus, the naked-eye 3D technology is the new trend of technology development.

Slit grating technology, lenticular lens, and liquid crystal lens technology are mainstream 3D display technologies. The slit grating technology has advantages with simple manufacturing process, and light weight, meanwhile the thickness is not greater than 200 μm. Hereafter, the distance between the slit and the pixel may be effectively reduced, and thus is suitable for displays in small-dimension and high PPI. However, the transmittance of slit grating technology is low, and the corresponding manufacturing cost afterwards may be high. As far as the lenticular-lens naked-eye 3D technology is concerned, it's also based on spacial pixels division with parts of sub-pixels rendering for left eye and others for the right eyes, wherein the resolution is decreased by half when compared to the 2D display technology. But lenticular-lens technology stands out for low transmission loss. Based on such technologies, the pixels should be placed on the focal planes of lenticular-lens, i.e., the focal length defines the space between the subpixels and lenticular-lens. Referring to FIG. 1, the thickness of a conventional polarizer 50 (˜100 μm), is comparable with the that of the lenticular lens 60. Hereafter, it limits the floor level of decreasing focal length. And usually the focal length of the lenticular lens is larger. With increasing display resolution and decreasing subpixels size as the technology boosts up, a smaller focal length of the lenticular lens is required, which has become a barricade in developing high resolution 3D devices in the next generation. Thus, how to reduce the focal length of the lenticular lens is a problem to be overcome during the manufacturing process.

### SUMMARY

The present disclosure relates to a lenticular lens film and a 3D display device for decreasing the space between the subpixels and lenticular lens film in developing high resolution 3D display device, wherein the focal length of the lenticular lens may also be effectively reduced.

In one aspect, a lenticular lens film includes: a substrate comprising a front surface and a back surface; a plurality of lenticular lenses, each of curved surfaces of the lenticular lenses are arranged on the front surface of the substrate in parallel, and the curved surfaces of the lenticular lenses faces away from the front surface of the substrate; and a plurality of wire grating polarizers, includes: a dielectric layer formed on the back surface of the substrate; a metallic layer comprising a plurality of metal strips in periods arranged on the dielectric layer, the metal strips are parallel to each other and are spaced apart from each other.

Wherein the lenticular lens film further includes: at least one aligning target formed on the back surface of the substrate, the aligning target is arranged in the rim of the metallic layer for aligning the lenticular lens film and the display during an assembly process, and the aligning target is made by the same material with the metal strip.

Wherein a shape of the aligning target is T-shaped, square-shaped, round square-shaped, round-shaped, circular-shaped, cross-shaped or counter-cross-shaped.

Wherein the metal strip is made by aluminum, silver, or gold, and the dielectric layer is made by silicon dioxide, silicon oxide, magnesium oxide, silicon nitride, titanium oxide or titanium pentoxide.

Wherein an included angle between an extending direction of the metal strips and an axis-extending direction of the lenticular lens is larger than or equal to a predetermined angle.

Wherein the predetermined angle is 0 degree.

Wherein the sum of the width of one metal strip and the distances between the respective metal strip with two adjacent metal strips is in a range from 20 to 500 nm (i.e., periods), wherein the ratio of the metal strip width to the periods is in the range from 0.1 to 0.9, and the thickness of the metal strips is in a range from 20 to 200 nm.

Wherein the substrate is made by transparent materials comprising polyethylene terephthalate (PET), Amorphous Polyethylene Terephthalate (APET), Polycarbonate (PC), polymethyl methacrylate (PMMA) or glass.

Wherein the metallic layer is made by deep ultraviolet (DUV) lithography technology, hologram technology, or roll to roll nano-imprint technology.

In another aspect, a 3D display device includes: a lenticular lens film includes: a substrate comprising a front surface and a back surface; a plurality of lenticular lenses, each of curved surfaces of the lenticular lenses are arranged on the front surface of the substrate in parallel, and the curved surfaces of the lenticular lenses faces away from the front surface of the substrate; a plurality of wire grating polarizers, includes: a dielectric layer formed on the back surface of the substrate; a metallic layer comprising a plurality of metal strips arranged on the dielectric layer, the metal strips are parallel to each other and are spaced apart from each other; and a display panel arranged to be close to the metallic layer of the wire grating polarizer.

In such configuration, protection films may be excluded for the wire grating polarizer in the lenticular lens film, when compared to the conventional polarizer, such that the thickness of the wire grating polarizer is smaller than the conventional polarizer. This may effectively address the dilemma of the required decreasing focal length brought by increasing display resolution and corresponding decreasing sub-pixels sizes, and the relative larger space partly contributed by the thicker conventional polarizer. Moreover, such configurations have physical metal targets, which poses great advantages over optical targets in transparent lenticular-films made by micro-structures. A total solution in combination of lenticular film with metal wire grids polarizer saves the following processing procedures.

### BRIEF DESCRIPTION OF THE DRAWINGS

FIG. 1 is a cross sectional view of the conventional display device.

FIG. 2 is a cross sectional view of the lenticular lens film in accordance with one embodiment.

FIG. 3 is a schematic view showing the shapes of the aligning targets of the lenticular lens film in accordance with one embodiment.

FIG. 4 is a cross sectional view of the 3D display device in accordance with one embodiment.

FIG. 5 is a top view of the 3D display device of FIG. 4.

### DETAILED DESCRIPTION OF THE EMBODIMENTS

Embodiments of the invention will now be described more fully hereinafter with reference to the accompanying drawings, in which embodiments of the invention are shown.

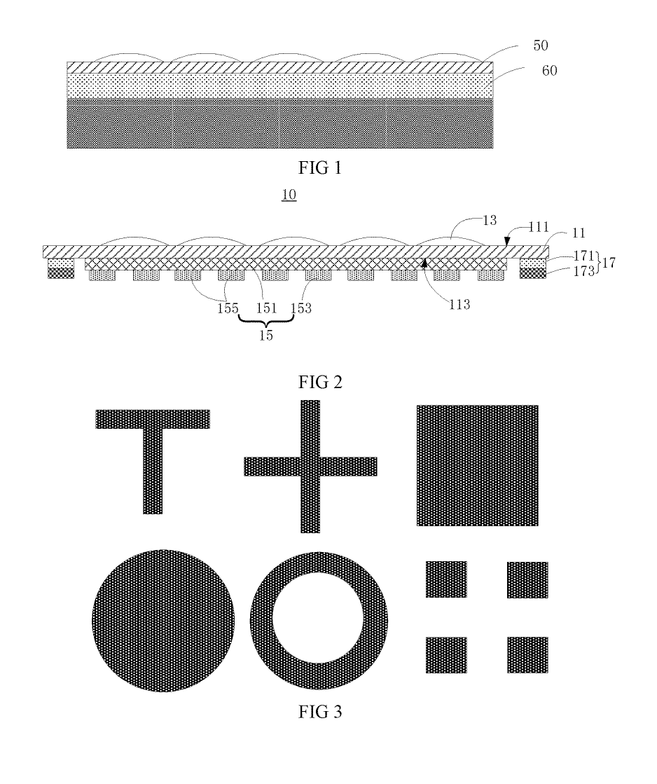

FIG. 2 is a cross sectional view of the lenticular lens film in accordance with one embodiment. The lenticular lens film 10 includes a substrate 11, a plurality of lenticular lenses 13, and a plurality of wire grating polarizers 15.

The substrate 11 includes a front surface 111 and a back surface 113 opposite to the front surface 111. The substrate 11 may be made by transparent materials, including polyethylene terephthalate (PET), Amorphous Polyethylene Terephthalate (APET), Polycarbonate (PC), polymethyl methacrylate (PMMA) or glass.

The curved surfaces of each of the lenticular lenses 13 are arranged on the front surface 111 of the substrate 11 in parallel, and the curved surfaces of the lenticular lenses 13 faces away from the front surface 111 of the substrate 11.

The wire grating polarizer 15 includes a dielectric layer 151 and a metallic layer 153. The dielectric layer 151 is formed on the back surface 113 of the substrate 11. The dielectric layer 151 is made by transparent materials, including silicon dioxide, silicon oxide, magnesium oxide, silicon nitride, titanium oxide or titanium pentoxide. It can be understood that the thickness of the dielectric layer 151 may be configured in accordance with real scenarios.

The metallic layer 153 includes a plurality of metal strips 155 arranged on the dielectric layer 151. The metal strips 155 are parallel to each other and spaced apart from each other in periods. For clarity, the sum of the width of one metal strip 155 and the distances between two adjacent metal strips 155 is in a range from 20 to 500 nm (i.e., periods), wherein the ratio of the metal strip to the periods is in the range from 0.1 to 0.9. The thickness of each of the metal strips 155 is in a range from 20 to 200 nm. The metallic layer 153 is made by materials having a large imaginary reflective index, such as aluminum, silver and gold, but this definition does not mean a limited materials species should be used.

The metallic layer 153 is made by deep ultraviolet (DUV) lithography technology, hologram technology, or roll to roll nano-imprint technology.

An included angle between an extending direction of each of the metal strips 155 and an axis-extending direction of the lenticular lens 13 is smaller than or equal to a predetermined angle. In the embodiment, the predetermined angle is 0 degree. That is, the extending direction of each of the metal strips 155 is parallel to the axis-extending direction of the lenticular lens 13. It can be understood that the predetermined angle may be adjusted in accordance with real scenarios. In an example, with respect to the mobile terminals horizontally displaying 3D effects, the axis direction of the top polarizer is usually parallel to the long side of the mobile terminal, and the direction of the metal strip is parallel to the short side of the mobile terminal. The axis-extending direction of the lenticular lens may be parallel to the short side or the included angle may be formed by the axis-extending direction and the short side so as to accomplish the horizontal 3D effect.

It can be understood that when the TE polarized beams enters the metallic layer 153, the electrons may freely oscillate along the extending direction of the metal strip 155, and the TE polarized beams are reflected by the metallic layer 153, wherein the polarized direction of the TE polarized beams is parallel to the metal strip 155. With respect to the TM polarized beams having the polarized direction perpendicular to the extending direction of the metal strip 155, as the width of the metal strip 155 is smaller than the wavelength of the incident light beams, the oscillation of the electrons along the direction is limited, and the TM polarized beams may pass through directly.

The lenticular lens film 10 further includes at least one aligning target 17 formed on the back surface 113 of the substrate 11. The aligning target 17 is arranged in a rim of the wire grating polarizer 15. During the assembling process of the lenticular lens film 10 and the display panel (not shown), the aligning target 17 may be adopted to conduct the alignment. In the embodiment, the lenticular lens film 10 includes four aligning targets 17, and every two of the aligning targets 17 are symmetrically arranged on the diagonal positions of the wire grating polarizer 15, which is the non-display areas. It can be understood that the locations of the aligning target 17 may be configured in accordance with real scenarios.

In the embodiment, the aligning target 17 includes a bottom layer 171 and a aligning mark 173. The materials of the bottom layer 171 is the same with that of the dielectric layer 151, and the materials of the aligning mark 173 is the same with that of the metallic layer 153. The aligning target 17 and the wire grating polarizer 15 are manufactured at the same time. Specifically, when the dielectric layer 151 is formed, the bottom layer 171 is also formed at the location where the aligning target 17 has to be configured. When the metallic layer 153 is formed, the aligning mark 173 is also formed on the corresponding bottom layer 171. As the aligning mark 173 is made by metallic material, instead of transparent materials, such that a clearer edge may be obtained within the optical imaging system, when being compared with the conventional aligning target. This contributes to the alignment between the lenticular lens film 10 and the display panel. In addition, the wire grating polarizer 15 may be manufactured at the same time. Not only the manufacturing process is simplified, but also the efficiency is enhanced.

It can be understood that, in other embodiments, the bottom layer 171 may be omitted.

It can be understood that, in other embodiments, the aligning mark 173 may be made by opaque materials.

It can be understood that lenticular-lens naked-eye 3D technology relies on the adjustment of the optical transmission path with respect to the left/right eye images by the lenticular lens, wherein precise alignment between the left/right display pixel and the central location of the lens is a key prerequisite. Thus, the assembly precision between the 3D lenticular lens and the display panel is the important factor affecting the 3D image performance, such as the crosstalk and the central view point. Conventionally, as the aligning target may be made by transparent resin material, and thus it may be difficult to obtain aligning target with obvious characteristics during the manufacturing process. Usually, the contour of the aligning target is strengthened by adopting light scattering with micro-structure, however, the edge obtained by the light scattering technology is not clear enough. That is, certain deviation exists with respect to the aligning target itself. As the aligning target 17 is made by opaque materials, clear edges may be obtained, which contributes to the alignment between the lenticular lens film 10 and the display panel.

As shown in FIG. 3, the shape of the aligning target 17 may be T-shaped, square-shaped, round square-shaped, round-shaped, circular-shaped, cross-shaped or counter-cross-shaped.

In view of the above, the protection film may be omitted with respect to the wire grating polarizer 15 of the lenticular lens film 10, when compared to the conventional polarizer, such that the thickness of the wire grating polarizer 15 is smaller than the conventional polarizer. This may effectively enhance the smaller focal length issue and the larger distance between the pixel and the lens caused by increasing the resolution rate and by decreasing the pixel dimension.

In addition, the wire grating polarizers 15 and the lenticular lenses 13 are respectively formed on two opposite surfaces of the substrate 11. Compared to the conventional polarizer, the steps of attaching the polarizers and the lenticular lens may be simplified, and thus the efficiency may be enhanced.

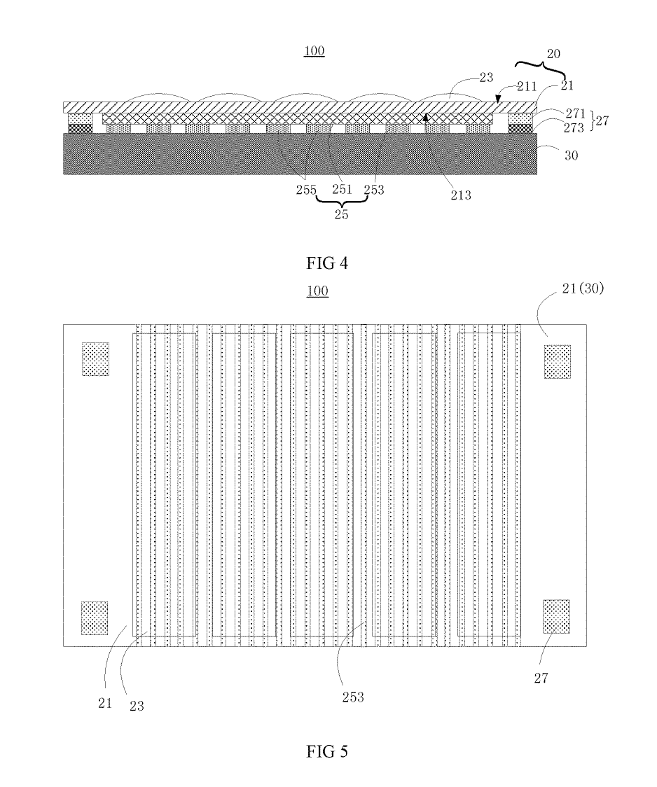

Referring to FIGS. 4 and 5, a display device 100 includes a lenticular lens film 20 and a display panel 30. The lenticular lens film 20 includes a substrate 21, a plurality of lenticular lenses 23, and a plurality of wire grating polarizers 25. The substrate 21 includes a front surface 211 and a back surface 213 opposite to the front surface 211.

The curved surfaces of each of the lenticular lenses 23 are arranged on the front surface 211 of the substrate 21 in parallel, and the curved surfaces of the lenticular lens 23 extend along a direction facing away from the front surface 211 of the substrate 21.

The wire grating polarizer 25 includes a dielectric layer 251 and a metallic layer 253. The dielectric layer 251 is formed on the back surface 213 of the substrate 21. The metallic layer 253 includes a plurality of metal strips 255 arranged on the dielectric layer 251.

The lenticular lens film 20 further includes at least one aligning target 27 formed on the back surface 213 of the substrate 21. The aligning target 27 is arranged on an edge of the wire grating polarizer 25, and is arranged between the display panel 30 and the lenticular lens film 20 for alignment the lenticular lens film 20 and the display panel 30 during an assembly process.

In the embodiment, the lenticular lens film 20 includes four aligning targets 27, and every two of the aligning targets 27 are symmetrically arranged on the diagonal positions of the wire grating polarizer 25, which is the non-display areas. It can be understood that the locations of the aligning target 27 may be configured in accordance with real scenarios.

In other embodiments, the aligning mark 27 may be made by opaque materials to obtain clear edges within the optical imaging system such that the lenticular lens film 20 and the display panel 30 may be precisely aligned in the assembly process.

The display panel 30 is arranged to be close to the metallic layer 253 of the wire grating polarizers 25. The display panel 30 may be an OLED display panel or a LCD display panel for displaying images.

In view of the above, the protection film may be omitted with respect to the wire grating polarizer 15 of the lenticular lens film 10, when compared to the conventional polarizer, such that the thickness of the wire grating polarizer 15 is smaller than the conventional polarizer. This may effectively enhance the smaller focal length issue and the larger distance between the pixel and the lens caused by increasing the resolution rate and by decreasing the pixel dimension. In addition, the wire grating polarizers 25 and the lenticular lenses 23 are respectively formed at two opposite surfaces of the substrate 21. Compared to the conventional polarizer, the process of respectively attaching the polarizer and the lenticular lens may be simplified, which enhances the operations efficiency.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A lenticular lens film, comprising:
a substrate comprising a front surface and a back surface;
a plurality of lenticular lenses, each of curved surfaces of the lenticular lenses are arranged on the front surface of the substrate in parallel, and the curved surfaces of the lenticular lenses faces away from the front surface of the substrate; and
a plurality of wire grating polarizers, comprises:
a dielectric layer formed on the back surface of the substrate;
a metallic layer comprising a plurality of metal strips arranged on the dielectric layer, the metal strips are parallel to each other and are spaced apart from each other in periods.

2. The lenticular lens film claimed in claim 1, wherein the lenticular lens film further comprises:
at least one aligning target formed on the back surface of the substrate, the aligning target is arranged in a rim of the metallic layer for aligning the lenticular lens film and the display during an assembly process, and the aligning target is made by the same material with the metal strip.

3. The lenticular lens film claimed in claim 2, wherein a shape of the aligning target is T-shaped, square-shaped, round square-shaped, round-shaped, circular-shaped, cross-shaped or counter-cross-shaped.

4. The lenticular lens film claimed in claim 1, wherein the metal strip is made by aluminum, silver, or gold, and the dielectric layer is made by silicon dioxide, silicon oxide, magnesium oxide, silicon nitride, titanium oxide or titanium pentoxide.

5. The lenticular lens film claimed in claim 1, wherein an included angle between an extending direction of the metal strips and an axis-extending direction of the lenticular lens is larger than or equal to a predetermined angle.

6. The lenticular lens film claimed in claim 5, wherein the predetermined angle is 0 degree.

7. The lenticular lens film claimed in claim 1, wherein a sum of a width of one metal strip and the distances between the respective metal strip with two adjacent metal strips is in a range between 20 and 500 nm, wherein a ratio of the width of the metal strip to the sum is approximately in a range between 0.1 and 0.9, and a thickness of the metal strips is in a range between 20 and 200 nm.

8. The lenticular lens film claimed in claim 1, wherein the substrate is made by transparent materials comprising polyethylene terephthalate (PET), Amorphous Polyethylene Terephthalate (APET), Polycarbonate (PC), polymethyl methacrylate (PMMA) or glass.

9. The lenticular lens film claimed in claim 1, wherein the metallic layer is made by deep ultraviolet (DUV) lithography technology, hologram technology, or roll to roll nano-imprint technology.

10. A 3D display device, comprising:
a lenticular lens film, comprising:
a substrate comprising a front surface and a back surface;
a plurality of lenticular lenses, each of curved surfaces of the lenticular lenses are arranged on the front surface of the substrate in parallel, and the curved surfaces of the lenticular lenses faces away from the front surface of the substrate;
a plurality of wire grating polarizers, comprises:
a dielectric layer formed on the back surface of the substrate;
a metallic layer comprising a plurality of metal strips arranged on the dielectric layer, the metal strips are parallel to each other and are spaced apart from each other; and
a display panel arranged to be close to the metallic layer of the wire grating polarizer.
